(19) United States
(12) Patent Application Publication
(10) Pub. No.: US 2011/0082817 A1
(43) Pub. Date: Apr. 7, 2011

(54) METHOD FOR POSTHUMOUS DELIVERY OF GREETING CARDS

(75) Inventor: Patricia A. Vandervort Stiles, Belton, MO (US)

(73) Assignee: HEREAFTER GREETING CARDS CO., LLC, Belton, MO (US)

(21) Appl. No.: 12/790,147

(22) Filed: May 28, 2010

Related U.S. Application Data
(60) Provisional application No. 61/247,740, filed on Oct. 1, 2009.

(51) Int. Cl. G06Q 90/00

(52) U.S. Cl. 705/500

(57) ABSTRACT

The present process is a method whereby a greeting card sender may arrange and schedule the delivery of pre-prepared greeting cards to greeting card recipients after the death of the greeting card sender. A greeting card sender selects and completes greeting cards with personal messages and the like as well as instructions for sending the greeting cards. The sender gives the cards and the instructions to a card trustee. Arrangements are also made for notifying the card trustee when the sender passes away. When the trustee is notified that the sender has passed away, the trustee executes the instructions given in mailing instructions or legacy data sheets and sends the greeting cards to the recipients at designated times in accordance with the instructions.

This application claims the priority benefit of U.S. Provisional Patent Application No. 61/247,740 filed on Oct. 1, 2009.

### FIELD OF THE INVENTION

The present invention relates to a method for a greeting card sender to arrange for and control the distribution of pre-prepared greeting cards and messages to friends and family so that the delivery of such greeting cards occurs at pre-selected times after the death of the greeting card sender.

### BACKGROUND OF THE INVENTION

Greeting cards have long been in use by individuals who wish to send private, caring or humorous messages to acquaintances, friends and family members. After an individual is deceased may be an opportune time for the deceased individual to send a comforting or helpful message to a friend or family member. What is needed is a method for arranging, managing and delivering greeting cards for a person who is deceased.

### SUMMARY OF THE INVENTION

The purpose of the present process is to provide a method whereby a greeting card sender may arrange and schedule the delivery of pre-prepared greeting cards to greeting card recipients after the death of the greeting card sender. The method is mostly conducted by a greeting card sender and a greeting card trustee. The prospective greeting card sender selects greeting cards and inscribes the greeting cards with personal messages or includes a letter or other personal message with each greeting card. The sender places each greeting card in an envelope, seals the envelope and writes the recipient's name on the front of the envelope and attaches a send date reference to the back of the envelope to indicate when the card should be sent to the recipient. The sender then completes a legacy data sheet for each recipient which includes at least the name of each recipient, the date of birth of each recipient, and the last known address of the recipient as well as send date instructions for each greeting card to be sent to the recipient. The completed enveloped cards and legacy data sheets are collected in a sender package and given to the greeting card trustee. The greeting card sender also completes a time of passing notification postcard. The time of passing notification postcard may be included with a living will or other instrument or it may given to a trusted friend or family member. In any case, the time of passing notification postcard is mailed to the greeting card trustee when the sender is deceased. The greeting card trustee retains the cards and the legacy data sheets. Upon receipt of the date of passing notification postcard, the greeting card trustee commences sending cards to recipients which are later in time than the date references inscribed on the back of the greeting card envelopes. Thus, if a greeting card envelope is indicated for Jason Smith for his tenth birthday and his 10th birthday falls 18 months after the sender's date of passing, then the greeting card trustee will send the appropriate greeting card to the address given in the legacy data sheet prior to the date of birth recorded in the legacy data sheet. Conversely, if, for example, Jason Smith's tenth birthday falls prior to the sender's date of passing, then the greeting card for the tenth birthday will be retained and not sent. Thus, for example, a greeting card sender might arrange to send greetings to young grandchildren later in their lives or on special occasions such as weddings, graduations, birthdays and the like. A process could be arranged whereby a greeting card trustee may monitor various local news outlets to detect when weddings, graduations and the like are announced. Or, the greeting card trustee might maintain email contacts with sender's family members in order to monitor the occurrence of special occasions such as weddings and graduations.

### BRIEF DESCRIPTION OF THE DRAWINGS

FIG. 1 is a flow chart showing the process steps for the posthumous greeting card process.

FIG. 2 is a schematic view of a posthumous greeting card pack including a box, greeting cards, greeting card envelopes, mailing instructions, a date of passing postcard and a return envelope for use in the posthumous greeting card process and in which the elements of the pack are not drawn to scale.

FIG. 3 shows an example mailing instructions to be temporarily affixed to each card envelope.

FIG. 4 shows an example date of passing postcard to be sent to the trustee upon death of the sender.

FIG. 5 shows an example legacy data sheet for use in the posthumous greeting card process.

### DETAILED DESCRIPTION

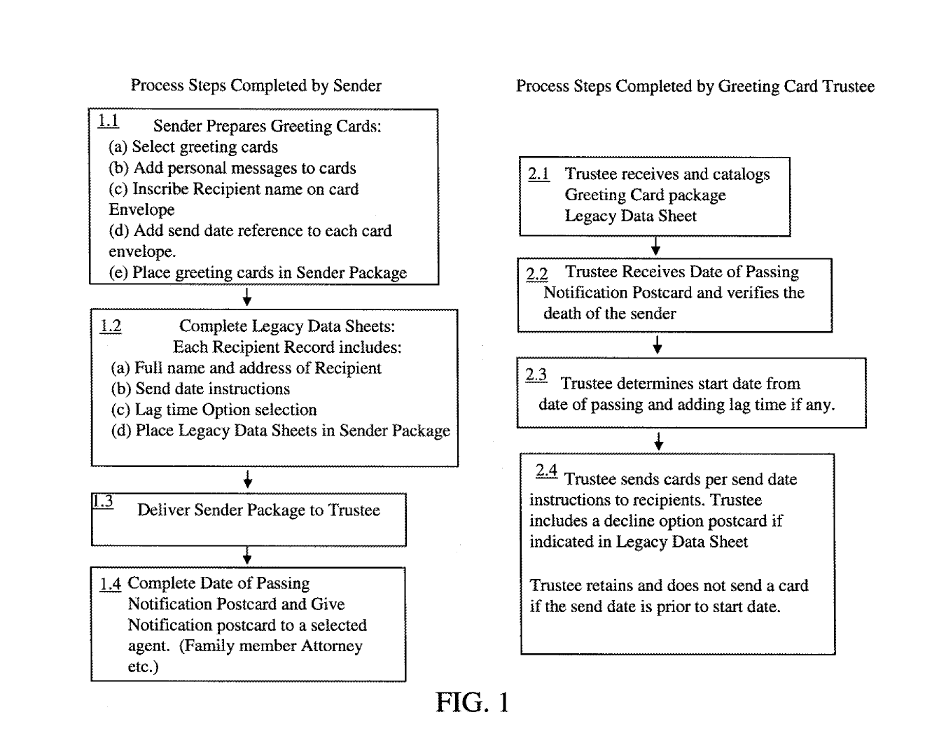

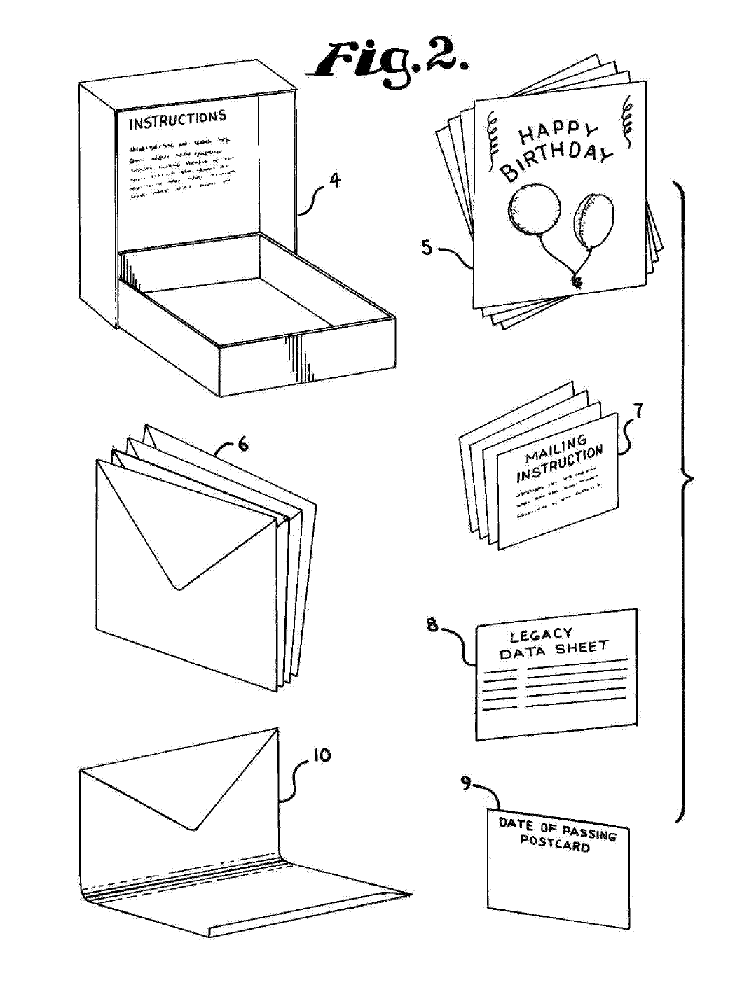

The process steps of the posthumous greeting card process are shown in FIG. 1. As can be seen in FIG. 1, the posthumous greeting card process includes steps which are performed by a greeting card sender and steps which are performed by a greeting card trustee. The steps performed by the sender are shown in steps 1.1-1.4 of FIG. 1 which will be described in greater detail below. The steps performed by the trustee are given in steps 2.1-2.4 of FIG. 1 which will also be described in greater detail below. The materials utilized in the process may be supplied as a pack or assembly and distributed in a box 4. In addition to the box 4, the pack may include greeting cards 5, greeting card envelopes 6, mailing instructions 7, legacy data sheets 8, a date of passing post card 9 and a return envelope 10 as generally shown in FIGS. 2-4. The process can be performed without the legacy data sheets 8, in which case the legacy data sheets 8 would not be included in the pack or box 4.

The greeting cards 5 may be categorized into several categories including cards directed towards various themes such as 1) holidays, anniversaries birthdays or special occasions; 2) religious, ethnic or racial; 3) animals; 4) family relationships (e.g. parent, child, etc.); 5) military; 6) lovers; or 7) universal or general messages. The greeting card trustee typically will also serve as the supplier of the greeting cards and handle the design and printing of the greeting cards 5. The trustee may allow the sender to select cards 5 from any or all of the categories of themed cards or the trustee may provide prepackaged cards organized by theme and supplied in a box 4 along with the card envelopes 6, mailing instructions 7, date of passing postcard 9 and return envelope 10. The box may also include one or more legacy data sheets 8.

Steps 1.1-1.4 shown in FIG. 1 describe the steps which are performed by the card sender. These steps are performed by the sender based upon instructions provided by the card supplier or trustee. The instructions may be included in the box 4 of greeting cards 5 purchased by the sender, printed on the box 4 itself or supplied separately including through electronic means such as posting on a website operated by the card trustee/supplier. The contents of the box 4 may also be printed on the box 4.

In step 1.1 and following the instructions provided by the card supplier, the greeting card sender (a) selects individual greeting cards 5 from such categories or themes as described above or a box 4 of greeting cards 5 organized by theme, (b) optionally includes personal messages which the sender inscribes on or includes with each card 5, (c) places each card 5 in an envelope 6 and inscribes the name of the recipient on the front of the card envelope 6, (d) adds mailing instructions 7 with a send date reference 11 to each card envelope 6 and finally, (e) deposits the completed cards 5 inserted in envelopes 6 with mailing instructions 7 attached in the return envelope or sender package 10. In one embodiment, the sender inscribes only the name of the recipient on the card envelope 6 because the address of the recipient may change at a later time. The card trustee will have responsibility for tracking and updating the current address of the recipient. Alternatively, the sender may print the mailing address for the recipient on the envelope 6 with instructions to the trustee to verify that the address remains accurate prior to mailing. It is also foreseen that the name and last known address of the intended recipient could be included on the mailing instructions 7 along with the name of the sender.

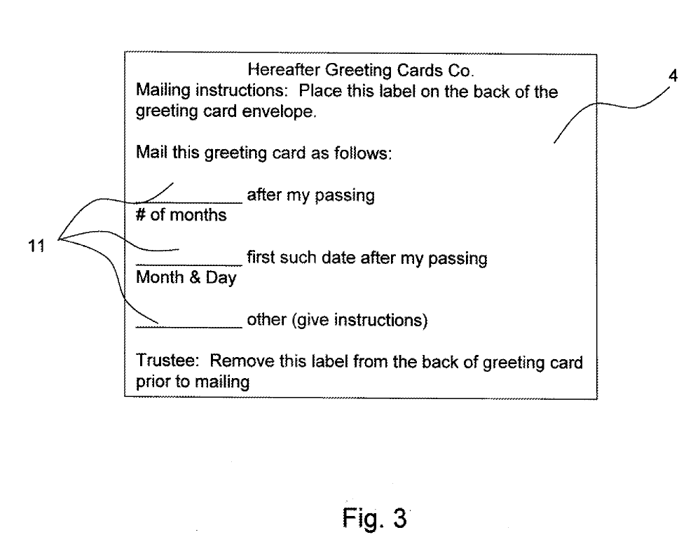

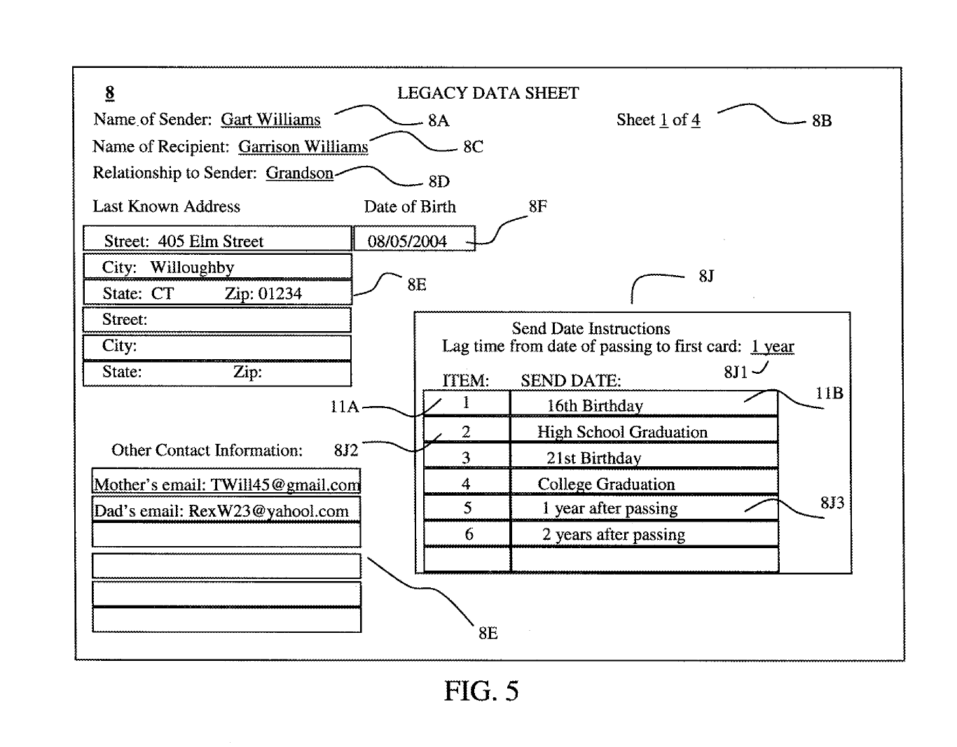

The mailing instructions 7, shown in FIG. 3, preferably comprise a pre-printed note with a releasable adhesive on the back to allow the instructions 7 to be removably adhered to the envelope 6. The mailing instructions may be supplied as multiple notes on a single sheet or a pad of notes. The send date reference 11 is generally printed on the mailing instructions 7 by the sender and may be a date or an indication of months after the passing of the sender that the cards should be sent or may it be in the form of a send date code 11A such as “A”, “B”, “C” or “1”, “2” or “3” as shown in more detail in a Send Date Instructions section 8J of the legacy data sheet 8 shown in FIG. 5 and described hereafter. In Step 1.2, the Send Date Instruction section 8A of the legacy data sheet 8 includes instructions which correlate the send date code 11A with send date instructions 11B.

Step 1.2 comprises completion of the legacy data sheet 8, and is best understood by referring to FIG. 5 which provides an example legacy data sheet 8. As can be seen in FIG. 5, legacy data sheet 8 has a series of fields which define who receives a particular greeting card 5 and when they receive it. Recall that each greeting card envelope 6 bears the name of the recipient and mailing instructions 7 with a send date code adhered to the back of the envelope possibly in the form of the send date reference 4. In fields 8A-8D, the sender completes these fields to indicate: the sender's name (8A), the data sheet number and total number of data sheets (8B), the recipient's name (8C) and the relationship of the recipient to the sender (8D) respectively. In the recipient contact information section 8E, the sender provides the current address of the recipient. If, at a later time, the recipient changes address, the trustee would have the opportunity to record a new current address for the recipient in field 8E. The legacy data sheet may also include an additional contact information in section 8E for contact phone numbers or email addresses and the like which the card trustee would use to maintain contact with, for example, the recipient's parents or other close friends or relatives. With such contacts, the trustee could inquire and be notified of recipient address changes as well as events such as graduations and weddings. In field 8F, the sender provides the recipient's date of birth. This date may be used to determine send dates such as “recipients 16th birthday”.

The send date instructions section 8J records the sender's send date instructions. In field 8J1, the sender provides a lag time instruction. “Lag time” is the amount of time which will elapse between the date of the sender's death and the date the first item is mailed to the recipient. The send date instructions section 8J also includes a plurality of send date code fields 8J2 in which send date codes 11A may be inserted and a plurality of send date event fields 8J3 in which corresponding send dates or events for which cards are to be sent are to be inserted. Accordingly, in the example given in FIG. 5, if the sender's date of death is Oct. 21, 2019, which is less than one year prior to the recipient's 16th birthday listed in the first send date event field or send date instruction field 8J3, then the card for the recipient's 16th birthday will not be sent to the recipient. The sender may indicate any lag time or no lag time. For example, a lag time of ninety days may be preferred by certain customers.

Once the sender has completed a legacy data sheet 8 for each recipient, the sender places the legacy data sheets 8 in the sender package 10 with the sender's completed greeting cards 5 placed in envelopes 6 with mailing instructions 7 attached, as indicated in step 1.2 of FIG. 1. The sender, in step 1.3, delivers the completed sender package 10 to the trustee who may be the same as or different from the card supplier. It is to be understood that the system could be used without the legacy data sheet 8 if the mailing instructions 7 and associated envelope 6 for each card 5 provide information to determine the date of sending and the name and address of the recipient. It is also foreseen that the recipient's address and contact information could be included in the mailing instructions 7 to permit the trustee to possibly check the recipient's address before sending the card 5 on the prescribed date.

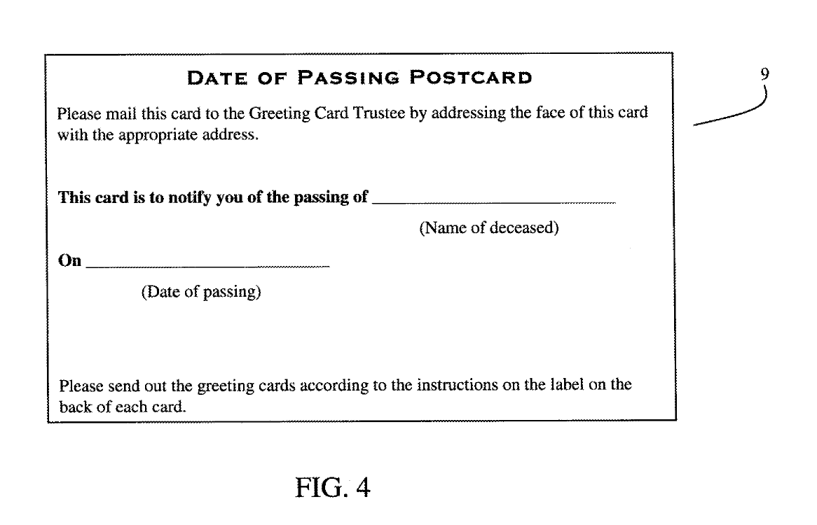

At this point, in step 1.4, the sender also completes a date of passing notification postcard 9, shown in FIG. 4, which is addressed to the trustee and delivers the postcard 9 to a trusted family member or other agent who is tasked to mail the postcard 9 to the trustee after the death of the sender. Alternatively, the date of passing notification postcard 9 may be included with a will, a living will or other such documents likely to be consulted at the time of the sender's death.

Once steps 1.1-1.3 of FIG. 1 have been completed by the sender, the trustee executes step 2.1 of FIG. 1. In step 2.1, the trustee receives and catalogs the contents of the sender package received from the sender. The trustee preferably sets up a sender file and sorts the greeting cards 5 in the sender package by recipient and then sequences the greeting cards for each recipient in the order of the send date codes, per the mailing instructions 7 affixed to the back of each greeting card envelope 6. The trustee preferably also sorts the legacy data sheets 8 by recipient.

In step 2.2, the trustee receives the date of passing notification card 9 of which delivery is initiated in step 1.4. The trustee preferably independently verifies the death of the sender. This may be done by obtaining a copy of the sender's death certificate or by obtaining a copy of the sender's obituary. This precaution may be of particular importance because the sender may have a strongly felt preference that a particular greeting card 5 or group of cards be sent only after the sender's death.

In step 2.3, the trustee determines a start date by adding a lag time (if any is indicated in space 3J1 on the legacy data sheet 3) to the sender's date of death. The trustee retains and refrains from sending cards 5 which have send date instructions yielding send dates prior to the calculated start date described above. Cards for occasions yet to occur and which logically must fall after the calculated start date are retained to be sent at a later time.

In step 2.4, the trustee sends the cards 5 pursuant to either the send date reference 11 on the mailing instructions 7 or based upon the send date instructions 11B on the legacy data sheet 8 which correspond to the send date code 11A on the mailing instructions 7. As noted above, the trustee may rely on contact information given in block 8E to obtain information concerning occasions in the life of the recipient such as graduations, weddings or the birth of a child. Cards which are for occasions that have not yet occurred and which logically must fall after the start date are retained to be sent at a later time.

By way of example, consider how Item 1 (in the first field 8J2) in the send date instructions section 8J on legacy data sheet 8 of FIG. 5 may be handled by the trustee. Suppose the sender dies on May 5, 2019. Because field 8J1 indicates a 1 year lag time, the start date is May 5, 2020. As can be seen from the recipient's date of birth as given in field 8F, the recipient's 16th birthday falls on Aug. 5, 2020. Thus, the first item, Item 1, indicated in the first field 8J2 and corresponding send date instruction in the first field 8J3 has a send date after the start date and thus the trustee should mail this card 5, by completing the address portion of the envelope 6 for Item 1 for the recipient indicated in field 8C with the last known address given in field 38E and then mailing the card 5 sufficiently prior to Aug. 5, 2020 so that the recipient receives it prior to Aug. 5, 2020.

The second send date instruction field 8J3, indicates another type of send date instruction which may require news media monitoring by the trustee or communication with other family members of the recipient if facilitated by entries in field 8E. When the trustee learns the recipient is about to graduate from high school, then the trustee would mail the card marked “2”, in the manner described above, to the recipient.

The card trustee may use the legacy data sheet 8 in a number of ways. It is highly likely, the card trustee would enter the information from the legacy data sheet 8 to a data base which would retain the data sheet 8 information so that it would be searchable by sender name and recipient name. The skilled reader will readily appreciate that the above legacy data collection method may be mostly conducted by means of a password secured internet website wherein senders may manage and update legacy data sheets 8, or rather update on-line legacy data files. Although it may be possible for senders to select and add messages to cards in an on-line environment, the applicant believes that many senders, especially older senders, might view messages which are not hand written or at least hand typed on stationary as being impersonal.

Numerous modifications and variations of this preferred embodiment may occur to those skilled in the art in light of this disclosure. Accordingly, it is expressly to be understood that these modifications and variations, and equivalents thereof, shall be considered to be within the spirit and scope of the invention as defined and described herein.

I claim:

1. A method for a greeting card supplier to coordinate the posthumous delivery of greeting cards for a greeting card sender, including the following steps:
a) offering the greeting card sender a plurality of greeting cards from which the greeting card sender may select at least one greeting card;
b) instructing the greeting card sender to complete each selected greeting card, place each selected greeting card in an envelope, inscribe a recipient's name on the front of each envelope, and removably affix mailing instructions on each envelope;
c) instructing the greeting card sender to complete a date of passing notification postcard and deliver the date of passing notification postcard to an authorized representative with instructions for the authorized representative to deliver the date of passing notification postcard to a greeting card trustee upon the death of the greeting card sender;
d) instructing the greeting card sender to collect each greeting card placed in an envelope with mailing instructions removably affixed thereto and convey these items to a greeting card trustee, and
e) instructing the greeting card trustee to send each greeting card upon receipt of the date of passing postcard and in accordance with the mailing instructions associated with each one greeting card.

2. The method as in claim 1 wherein the greeting card supplier is the greeting card trustee.

3. The method as in claim 1 further comprising the step of instructing the greeting card sender to complete a legacy data sheet for each recipient of each greeting card including at least the name of the greeting card sender, the name of the recipient, the address of the recipient and at least one send date instruction;

4. The method as in claim 3 wherein the mailing instructions comprise a removable adhesive note having at least one send date reference included thereon corresponding to a send date instruction on the legacy data sheet.

5. The method as in claim 3 further comprising instructing the greeting card sender to complete the legacy data sheet for each recipient of a greeting card further including a duration of time after death of the greeting card sender during which the greeting card sender does not desire a greeting card be sent to the recipient.

6. The method as in claim 1 wherein said step of offering a plurality of greeting cards comprises offering a plurality of greeting cards organized according to a plurality of themes from which the greeting card sender may select.

7. A method for a greeting card supplier to coordinate the posthumous delivery of greeting cards for a greeting card sender, including the following steps:
a) offering the greeting card sender a plurality of greeting cards from which the greeting card sender may select at least one greeting card;
b) instructing the greeting card sender to complete each selected greeting card, place each selected greeting card in an envelope, inscribe a recipient's name on the front of each envelope, and affix mailing instructions on each envelope;
c) instructing the greeting card sender to complete a date of passing notification postcard and deliver the date of passing notification postcard to an authorized representative with instructions for the authorized representative to deliver the date of passing notification postcard to a greeting card trustee upon the death of the greeting card sender;
d) instructing the greeting card sender to complete a legacy data sheet for each recipient of a greeting card including at least the name of the greeting card sender, the name of the recipient and the address of the recipient;
e) instructing the greeting card sender to collect the products of steps (a) and (c) in a sender package and convey the sender package to a greeting card trustee; and
f) instructing the greeting card trustee to send each greeting card upon receipt of the date of passing postcard and in accordance with the legacy data sheet and the mailing instructions associated with each greeting card.

8. The method as in claim 7 wherein the greeting card supplier is the greeting card trustee.

9. The method as in claim 7 wherein the mailing instructions comprise a removable adhesive note.

10. The method as in claim 7 further comprising instructing the greeting card sender to complete the legacy data sheet for each recipient of a greeting card further including a duration of time after death of the greeting card sender during which the greeting card sender does not desire a greeting card be sent to the recipient.

11. The method as in claim 7 wherein said step of offering a plurality of greeting cards comprises offering a plurality of greeting cards organized according to a plurality of themes from which the greeting card sender may select.

12. A method for posthumous delivery of greeting cards from a greeting card sender, including the following steps:
a) the greeting card sender selects a plurality of greeting cards, completes each greeting card, places each greeting card in an envelope, inscribes a recipient's name on the front of each envelope, and removably affixes mailing instructions on each envelope;
b) the greeting card sender completes a date of passing notification postcard and delivers the date of passing notification postcard to an authorized representative;
c) the greeting card sender collects the greeting cards placed in envelopes with mailing instructions affixed thereto n a sender package and conveys the sender package to a greeting card trustee;
d) the authorized representative delivers the date of passing notification postcard to a greeting card trustee upon the death of the greeting card sender,
e) the greeting card trustee sends each greeting card upon receipt of the date of passing postcard and in accordance with the mailing instructions associated with each greeting card.

13. The method as in claim 12 wherein the mailing instructions comprise a removable adhesive note having at least one send date reference included thereon.

14. The method as in claim 12 further comprising the steps of a greeting card supplier organizing a plurality of greeting cards according to a plurality of themes associated with the greeting cards and said step of the greeting card sender selecting greeting cards comprises said greeting card sender selecting a plurality of greeting cards organized according to one of the plurality of themes.

15. The method as in claim 12 wherein the greeting card supplier is the greeting card trustee.
